(19) United States
(12) Patent Application Publication
(10) Pub. No.: US 2012/0045544 A1
(43) Pub. Date: Feb. 23, 2012

(54) FROZEN DOUGH COMPRISING SACCHAROMYCES BAYANUS

(75) Inventors: Feng Xie, Overland Park, KS (US); Weizhu Yu, Morris Plains, NJ (US); Jesse Weilert, Edgerton, KS (US)

(73) Assignee: CSM Nederland B.V.

(21) Appl. No.: 13/202,549

(22) PCT Filed: Feb. 18, 2010
(86) PCT No.: PCT/NL10/50081

§ 371 Date: Oct. 28, 2011

Related U.S. Application Data
(60) Provisional application No. 61/154,086, filed on Feb. 20, 2009.

(51) Int. Cl. A21D 8/04; A21D 13/08; A21D 6/00; A21D 13/00

(52) U.S. Cl. 426/27; 426/62

(57) ABSTRACT

The present invention relates a frozen non-leavened farinaceous dough that can be leavened under ambient conditions before being baked, fried and/or boiled to produce a ready-to-eat foodstuff. More particularly, the invention provides a frozen non-leavened farinaceous dough containing at 10³ cells/g viable cells of an S. bayanus strain. The dough product according to the invention offers the advantage that the time window within which the leavened dough can be prepared for consumption is very broad, i.e. several hours. Another aspect of the present invention relates to a method of preparing a ready-to-eat cooked leavened dough product, said method comprising the steps of: ?thawing and leavening a frozen non-leavened dough as described above by keeping it under ambient temperature for 6-24 hours to obtain a leavened dough having a specific volume of at least 2.0 ml/g; and ?baking, frying and/or boiling the leavened dough.

### TECHNICAL FIELD OF THE INVENTION

The present invention provides a frozen farinaceous dough, more particularly a frozen dough that can be leavened under ambient conditions before being baked, fried and/or boiled to produce a ready-to-eat foodstuff.

### BACKGROUND OF THE INVENTION

Traditionally, leavened dough is prepared by adding live yeast (baker's yeast) to the dough and by proofing the dough prior to baking. Proofing usually refers to a process by which pieces of shaped yeast dough are raised or enlarged preparatory to their being baked. Thus pastries, rolls, breads and other bakery products must undergo proofing before being put in an oven to be baked. When dough intermixed with live yeast is placed in a warm moist environment, carbon dioxide is internally generated throughout the body of the dough to create myriad gas pockets. These gas pockets enlarge or raise the dough and also alter its texture.

When the proofed dough is baked, the resultant product is lighter and less chewy than dough products which are not raised prior to baking. Thus croissants, doughnuts, pan pizzas, rolls and breads must be properly proofed before being baked. Proofing therefore is the process by which the shaped yeast dough pieces are subjected to a moist, hot-air environment to raise the pieces, and a proofing cabinet is a chamber in which proofing takes place.

There is an increasing consumer demand for freshly prepared bakery products, such as bread, rolls, pastry, bagels, doughnuts. Furthermore, consumers wish to purchase freshly prepared bakery products at any time of the day and at various outlets such as supermarkets, food stores and restaurants. These consumer trends pose a special challenge for bakery products that are made from yeast leavened dough. Yeast leavening (proofing) is a time consuming process, meaning that it is impossible to instantaneously produce a yeast leavened ready-to-eat bakery product, unless the product has already gone through the leavening process. However, since yeast leavened dough usually is highly unstable, e.g. is vulnerable to collapse, it is not feasible to employ pre-leavened dough, unless the leavening process has been halted, for example, by freezing the leavened dough. Another issue with yeast leavened bakery products resides in the fact the leavening of the dough usually requires the use of special equipment, i.e. a proofing cabinet, in order to ensure good results. It will be easily understood that the operation of proofing cabinets requires special skills and that it is not practical to install proofing cabinets in outlets that do produce a limited volume of yeast leavened bakery products.

Thus, there is a need for yeast leavened dough products from which good quality ready-to-eat bakery products can be prepared almost instantaneously (on demand) and without using special equipment. Furthermore, these dough products should be sufficiently stable to allow them to be used in the preparation of a ready-to-eat bakery product within a relative broad time window.

The prior art describes frozen pre-proofed dough products that can be used in the preparation of freshly prepared bakery products. U.S. Pat. No. 4,406,911, for instance, discloses a frozen pre-proofed dough that can be baked into a finished loaf straight from the freezer. The dough is yeast-leavened and formed into loaves before freezing and maintains its shelf-life stability through the addition of hydrophobic colloids, film-forming proteins and surfactants.

U.S. Pat. No. 5,447,738 discloses a frozen pre-proofed dough that can be baked immediately from the freezer and contains a dough-improver ingredient, such as pectin or guar gum.

An important drawback of frozen pre-proofed dough products is that the ready-to-eat bakery products prepared therefrom usually lack volume, i.e. they have an undesirably dense (crumb) structure. Furthermore, the fact that these frozen products need to be thawed and baked in a single operation has a negative impact on preparation time as well as on product quality. Finally, pre-proofed dough products have the disadvantage that they are easily damaged and that they have a high volume to weight ratio, which impacts negatively on transportation and storage costs.

It is an objective of the present invention to provide a frozen dough product that can suitably be used to prepare a good quality yeast leavened bakery product and that does not suffer from the drawbacks described herein before.

### SUMMARY OF THE INVENTION

The inventors have realized the aforementioned objective by providing a non-proofed frozen dough product that can be leavened simply by keeping the dough under ambient conditions. During this keeping period the dough becomes thawed and the yeast starts to ferment the carbohydrates contained in the dough whilst simultaneously producing carbon dioxide, thereby producing and expanding a cellular dough structure. The dough product according to the present invention offers the advantage that the time window within which the leavened dough can be prepared for consumption is very broad, i.e. several hours. Thus, the present invention allows a single batch of frozen dough pieces to be leavened simultaneously by keeping this batch under ambient conditions for more than 6 hours, following which, during a time period that spans several hours, individual dough pieces from the batch can be processed on demand into good quality ready-to-eat bakery products. The advantageous properties of the frozen dough of the present invention are connected with the use of a special yeast strain, i.e. Saccharomyces bayanus.

S. bayanus is one of the 10 yeast species mentioned in the classification of Barnett et al., “Yeasts: Characteristics and Identification”, 3^{rd} ed., (2000), Cambridge University Press, Cambridge, UK. Unlike S. cerevisiae, which is another yeast species, S. bayanus is not employed commercially in the production of yeast-leavened dough. S. bayanus, however, is widely used in wine production, especially in the production of champagne. It is noted that S. bayanus has sometimes been referred to a S. cerevisiae ssp. bayanus. Throughout this document S. bayanus and S. cerevisiae ssp. bayanus. are considered synonyms.

WO 2007/117145 describes a dough that contains flour, water and at least 10⁵ cells/g of an S. bayanus strain. It is observed in this patent application that by using a strain of Saccharomyces bayanus in the preparation of yeast leavened dough overproofing can be avoided. The option of freezing a partially or fully proofed dough is mentioned in the application.

### DETAILED DESCRIPTION OF THE INVENTION

One aspect of the present invention relates to a frozen non-leavened farinaceous dough containing at least 10³ cells/g viable cells of an S. bayanus strain.

The term “leavened dough” as used herein refers to dough that has undergone a leavening process resulting in the formation of gas filled pockets throughout the dough. Freshly leavened doughs are characterised by the presence of elevated carbon dioxide levels in the gas filled pockets. Typical examples of leavened dough include bread dough, pastry dough (including e.g croissant and Danish pastry dough), bagel dough and doughnut dough. Cake batters and the like are not encompassed by the term leavened dough.

According to a particularly preferred embodiment, the frozen dough is contained in a package together with instructions for use, said instructions stating with pictures and/or words that the frozen dough is to be kept under ambient conditions for at least 6 hours before baking, frying or boiling. Even more preferably, the instructions for use state that the frozen dough is to be kept under ambient conditions for 8-24 hours, most preferably for 12-24 hours before baking, frying or boiling. Here the term “ambient conditions” refers to room temperature and atmospheric pressure.

According to one embodiment, the instructions for use further state with pictures and/or words that the frozen dough is to be covered whilst it is kept under ambient conditions, e.g. with a (water impermeable) foil or a wet cloth.

According to another embodiment of the present invention, the frozen dough is contained in a sealed package that is essentially water-impermeable. The frozen dough can suitably be kept under ambient conditions in the sealed package to thaw and leaven the dough. Since the sealed package is essentially water-impermeable, leavening can be achieved whilst avoiding that the dough surface dries out. Naturally, since the dough expands during the keeping period, the package must have sufficient volume to accommodate the expanding dough. Thus, preferably the sealed package can accommodate at least twice the volume of the frozen dough. Even more preferably the sealed package can accommodate at least three times the volume of the frozen dough. An example of a sealed package that can be used in accordance with the present invention is a bag made of flexible polymer film, e.g. a heat-sealable thermoplastic polymer film.

According to yet another embodiment, the frozen dough is contained in a sealed package together with instructions for use, said instructions stating with pictures and/or words that the frozen dough is to be kept in the sealed package under ambient conditions for at least 6 hours, preferably for 8-24 hours and most preferably for 12-24 hours before baking, frying or boiling.

The inventors have achieved very good results with S. bayanus strains exhibiting killer characteristics, i.e. strains that produce toxins that are fatal to other yeast strains. The phenomena of killer yeasts were discovered in 1965. Killer yeasts produce toxins as either proteins or glycoproteins, and these toxins are fatal to other yeast strains. Not all yeast strains are sensitive to killer toxins, and yeasts are currently classified as killer strains, sensitive strains, unaffected strains and competitive yeast strains. The sensitive yeast strains cannot survive when significant quantities of killer toxins are present in the must. The insensitive strains are affected by the presence of killer toxins. Competitive yeast strains are not killer strains, and they are insensitive to killer toxins. Toxicity is measured observing the inhibition of growth of one yeast strain in the presence of another strain. Research shows the killer toxins are more effective at pH values between 4 and 5. Several killer yeast strains are available commercially in active, dry form.

In a particularly preferred embodiment of the present invention, the S. bayanus strain employed is a killer yeast S. cerevisiae Killer (ssp. bayanus) deposited as IOC 18-2007 in the Collection de Levure d'Intérêt Biotechnologique and sold by Institut Oenologique de Champagne under the product code “IOC 18-2007”. Hence, in a particularly preferred embodiment, the latter strain is employed to produce a yeast-leavened dough in accordance with the present invention.

According to another preferred embodiment, the S. bayanus strain employed is an S. bayanus strain deposited as IOC 11-1002 in the Collection de Levure d'Intérêt Biotechnologique. This particular strain is commercially available from the Institut Oenologique de Champagne, Epernay, France and is designated on the product sheet as Saccharomyces cerevisiae (anc. Saccharomyces bayanus). On the product sheet the strain is described as having a high resistance to alcohol (>15 vol. %). It is further characterised as having a high alcohol conversion (16.5 g/l of sugar produces 1% of alcohol).

In accordance with the present invention S. bayanus is advantageously contained in the dough in a concentration of at least 3×10³ cells per g of dough. Preferably, S. bayanus is comprised in the dough in a concentration of 5×10³-10¹⁰, more preferably of 10⁴-10⁹ cells per g of dough.

The frozen non-leavened dough of the present invention typically has a specific volume of less than 2.0 ml/g. More preferably, the frozen non-leavened dough has a specific volume of less than 1.5 ml/g, most preferably of less than 1.3 ml/g.

The frozen dough of the present invention exhibits the advantageous property that it undergoes considerable volume increase as a result of yeast leavening when it is kept under ambient conditions for 6 hours or more. Typically, the specific volume of the dough increases to at least 2.0 ml/g when kept at a temperature of 20° C. for 6-24 hours. More preferably, said specific volume increases to at least 2.5 ml/g under these conditions. Most preferably, specific volume increases to at least 3.0 ml/g under these conditions.

The frozen dough according to the invention advantageously is a shaped dough, e.g. a ball-shaped, cylinder-shaped, disc-shaped or ring-shaped dough. More preferably, the dough is a shaped dough having a weight in the range of 20-800 grams, most preferably of 30-600 grams.

The frozen dough contains flour, water, yeast and optionally other bakery ingredients, such as emulsifiers, enzymes, ascorbic acid, etc. Typically, the frozen dough comprises 40-80 wt. % of flour and 10-50 wt. % of water. Preferably, the dough comprises 50-70 wt. % of flour and 20-40 wt. % of water.

The benefits of the present invention can be realized with a variety of dough based bakery products. Examples of such bakery products include bread (loaves and rolls), pastry, bagels and doughnuts. Thus, in a preferred embodiment the frozen dough is a bagel dough, a doughnut dough, a bread dough or a pastry dough.

Another aspect of the present invention relates to a method of preparing a ready-to-eat cooked leavened dough product, said method comprising the steps of:
thawing and leavening a non-leavened frozen dough as defined herein before by keeping it under ambient conditions for 6-24 hours to obtain a leavened dough having a specific volume of at least 2.0 ml/g; and
baking, frying and/or boiling the leavened dough.

Thawing and leavening of the frozen dough can be carried out under controlled humidity conditions. Preferably, however, humidity is not controlled during thawing and leavening. Thus, advantageously the method does not include proofing of the dough in a proofing cabinet. In order to prevent the dough surface from drying out during the keeping step, it may be advantageous to cover the dough with a water-impermeable film or with a wet cloth. Alternatively, if the frozen dough has been packaged in a water impenetrable packaging material, during the keeping step, the dough may remain in the package.

In a preferred embodiment of the present method the dough is kept under ambient conditions for 12-24 hours. Advantageously, the dough is kept under ambient conditions overnight. Thus, the frozen dough can be taken out of the freezer the day before it needs to be processed into a ready-to-eat bakery product. If, for example, the frozen dough can be adequately leavened by keeping it for 16 hours under ambient conditions and if the so leavened dough has a time window of 4 hours within which it can be processed into a high quality bakery product, only three daily operations are needed to realise availability of ready-to-bake leavened dough during 12 hours the next day. The following table illustrates how this may work for a bread dough that requires 16 hours of keeping under ambient conditions to become adequately leavened and that subsequently can be used in the production of a ready-to-eat bread during a time window of 4 hours (when still kept under ambient conditions):

| | Batch 1 | Batch 2 | Batch 3 |
|---|---|---|---|
| Out of freezer | Day 1; 2:00 pm | Day 1; 6:00 pm | Day 1; 10:00 pm |
| Ready for | Day 2; 6:00 am | Day 2; 10:00 am | Day 2; 2:00 pm |
| baking | | | |
| No longer | Day 2; 10:00 am | Day 2; 2:00 pm | Day 2; 6:00 pm |
| usable | | | |

The inventors have found that once the frozen dough has become leavened, the time window within which the leavened dough can suitably be processed can be extended considerably by keeping the leavened dough under refrigeration conditions. Typically, the leavened dough can be kept under refrigeration conditions for up to 16 hours before it is baked, fried and/or boiled. Preferably, the leavened dough is kept under refrigeration conditions for not more than 12 hours before being processed into a ready-to-eat bakery product. Also during refrigeration, the dough may be kept in its original package to prevent skin drying.

By using refrigeration to widen the time span within which a leavened dough can suitably be used in the preparation of a good quality bakery product, the number of daily thawing/leavening operations can be further reduced. This is illustrated in the following table which shows that only two thawing/leavening operations are needed to ensure availability of ready-to-bake leavened dough during a period of 18 hours. Also in this example use is made of a frozen bread dough that can be adequately leavened by keeping it under ambient conditions for 16 hours, but this time the leavened dough is kept under refrigeration conditions, thereby extending the time window during which ready-to-bake leavened dough can be used to 9 hours.

| | Batch 1 | Batch 2 |
|---|---|---|
| Out of freezer (ambient) | Day 1; 2:00 pm | Day 1; 11:00 pm |
| Ready for baking (refrigerated) | Day 2; 6:00 am | Day 2; 3:00 pm |
| No longer usable | Day 2; 3:00 pm | Day 2; 12:00 pm |

Baked products of excellent quality can be obtained by the present method by baking the leavened dough in an oven that was previously preheated to a temperature of at least 160° C., preferably of at least 200° C. Likewise, excellent products, such as doughnuts, can be obtained by (deep) frying the dough in a frying medium having a temperature of at least 150° C.

Bagels can suitably produced by the present method by introducing the leavened dough in boiling water followed by baking the boiled product.

The present method can also be used to produce freshly prepared doughnuts, simply by introducing the leavened dough into hot frying fat.

The invention is further illustrated by means of the following examples.

### EXAMPLES

### Example 1

A bread dough was prepared using the following recipe:

| Ingredient | Baker's percentage |
|---|---|
| Flour | 100.0 |
| Vital wheat gluten | 1.5 |
| Granulated Sugar | 9.4 |
| Salt | 2.1 |
| Wheat Protein Isolate (5000) | 0.9 |
| Bread dough conditioner | 1.2 |
| Sodium stearoyl lactylate | 0.5 |
| Soy Oil | 2.8 |
| Water | 51.0 |
| Ice | 18.7 |
| Compressed yeast | 0.3 |
| Dry yeast IOC 18-2007¹ | 1.5 |

¹A yeast strain ex Institut Oenologique de Champagne, Epernay, France; designated in the product sheet as S. cerevisiae Killer (anc. bayanus)

The bread dough was produced by mixing the above mentioned ingredients, using water having a temperature of less than 40° F. (5° C.). The ingredient blend is mixed until the dough is almost fully developed whilst ensuring that the final dough temperature remains below 70° F. (21° C.). Next, the dough is divided into a pieces of 170 g each, sheeted, and shaped into dough pieces. The dough pieces were arranged in a open tray and kept in a blast freezer for 1 hour. Then the frozen dough pieces were packed in a sealed bag and stored in a regular freezer.

After having been stored for 7 days in the freezer, the bags containing the frozen dough pieces were removed from the freezer, the frozen dough pieces were taken out of the bag and put into a tray. The frozen dough pieces were covered so as to prevent them from developing a dry skin and were left under ambient conditions (75° F./24° C.) for 15 hours. The fully leavened dough pieces so obtained were removed from the package and baked. The loaves of bread so obtained were evaluated by an expert panel. The panel found that in terms of appearance, taste and texture the bread was of good quality. It was further found that bread of acceptable quality could be produced even if the dough pieces were left under ambient conditions for a few more hours.

### Example 2

Bagels were produced using the following recipe:

| Ingredient | Baker's percentage |
|---|---|
| Flour | 100 |
| Vital Wheat Gluten | 2 |
| Polar ™ Bagel base¹ | 5 |
| Water | 37 |
| Ice | 11 |
| Dry yeast IOC 18-2007² | 0.075 |

¹Caravan Ingredients, Lenexa, KS, USA
²A yeast strain ex Institut Oenologique de Champagne, Epernay, France; designated in the product sheet as S. cerevisiae Killer (anc. bayanus)

The bagel dough was prepared by mixing the above mentioned ingredients, dividing into dough pieces of about 140 g and shaping. The dough pieces were arranged in a open tray and kept in a blast freezer for 1 hour. Then the frozen dough pieces were packed in a sealed bag and stored in a regular freezer.

After having been kept in the freezer for 7 days, the bags containing the frozen dough pieces were taken out of the freezer, transferred into a tray, covered to prevent drying out and left at room temperature (72° F./22° C.) for 7 to 30 hours of floor time and subsequently baked.

The optimum floor time for making an acceptable bagel was investigated. In this study, a regular bagel was used as a control. The regular bagel had been prepared in exactly the same fashion as described herein before, except that this time the yeast component was compressed baker's yeast (at 2 baker's percent).

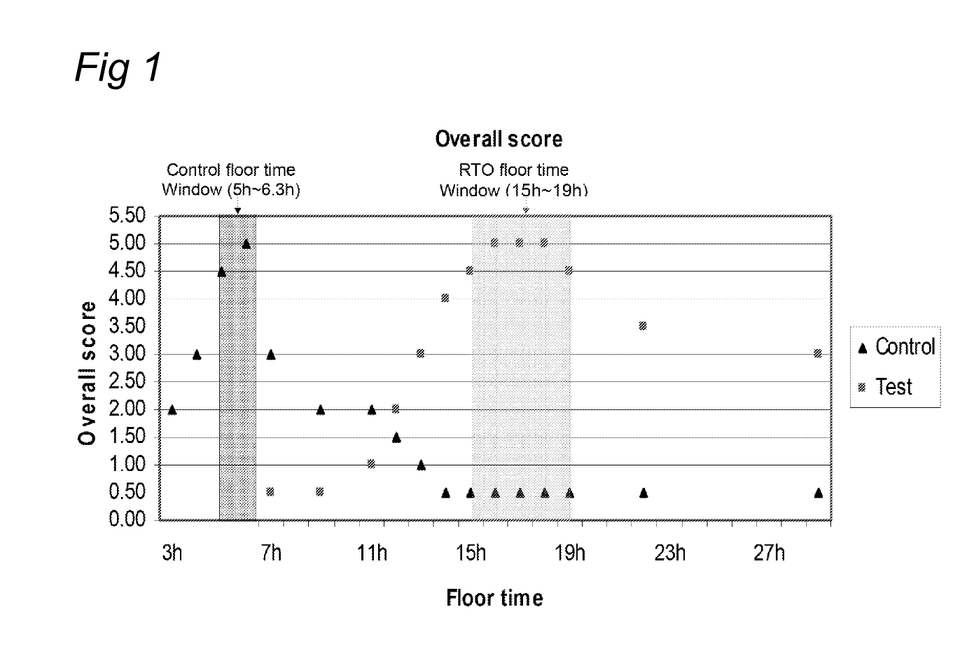

Following 7 hours of flour time dough pieces were baked every one or two hours. Bagel width, height, and volume were measured shortly after baking. Crust color, crumb structure, symmetry, and flavor were evaluated by an expert panel one day after baking. An overall score from scale 0 to 5 was given to the samples based on all the evaluations. A bagel of good quality has a score of 4.5 or higher. The results so obtained are depicted in FIG. 1.

From these results it can be concluded that the optimum floor time window for the bagels according to the invention is from 15 to 19 hours, whereas the optimum floor time window for the control bagels was from 5 to 6.3 hours. Naturally, optimum floor time window will vary depending on the dough recipe and further depends on the quality standard that needs to be met.

### Example 3

Example 2 was repeated, except that this time the frozen bagels were transferred from the freezer into a refrigerator where they were kept for 1-23 hours before being baked.

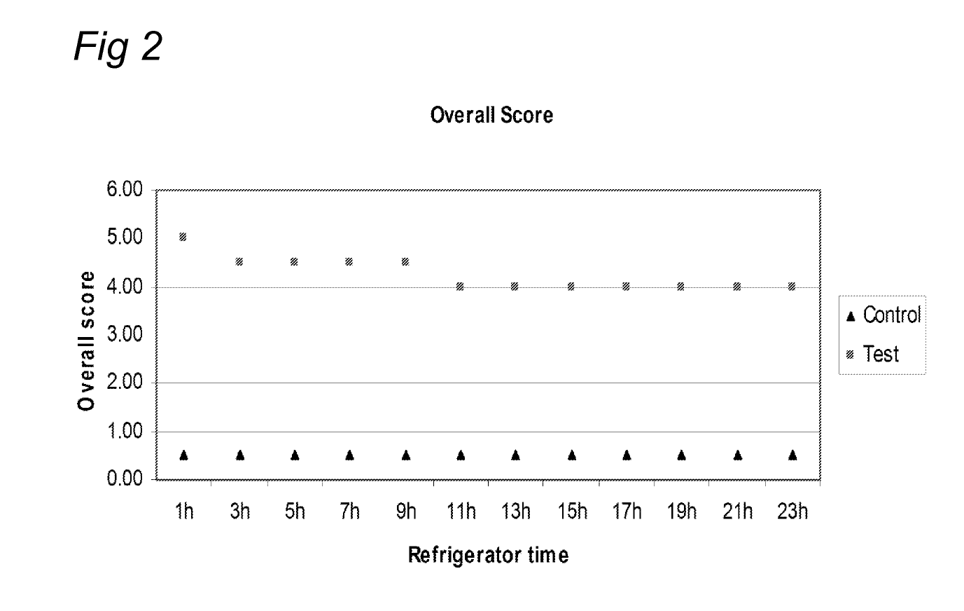

Every hour bagels were taken from the refrigerator and baked. Bagel width, height, and volume were measured shortly after baking Crust color, crumb structure, symmetry, and flavor were evaluated by an expert panel one day after baking. An overall score from scale 0 to 5 was given to the samples based on all the evaluations. The results so obtained are depicted in FIG. 2. Again a score of 4.5 or higher indicates that the bagel is of good quality.

From these results it can be concluded that the leavened dough pieces obtained after 15 hours of floor time can be kept in the refrigerator for up to 9 hours without a significant adverse effect on the quality of the baked end-product.

1-16. (canceled)

17. A frozen non-leavened farinaceous dough comprising at least 10³ cells/g viable cells of an S. bayanus strain, wherein the frozen dough is contained in a package together with instructions for use, said instructions stating with pictures and/or words that the frozen dough is to be kept under ambient conditions for at least 6 hours before baking, frying or boiling.

18. The frozen dough according to claim 17, wherein the frozen dough comprises at least 10⁴ cells/g viable cells of an S. bayanus strain.

19. The frozen dough according to claim 17, wherein the instructions for use state that the frozen dough is to be kept under ambient conditions for 8-24 hours before baking, frying or boiling.

20. The frozen dough according to claim 19, wherein the instructions for use state that the frozen dough is to be kept under ambient conditions for 12-24 hours before baking, frying or boiling.

21. The frozen dough according to claim 17, wherein the dough is selected from the group consisting of a killer yeast strain belonging to S. bayanus, an S. bayanus strain deposited as IOC 11-1002 in the Collection de Levure d'Intérêt Biotechnologique and combinations thereof.

22. The frozen dough according to claim 17, comprising at least 10⁴ cells of the S. bayanus strain per gram.

23. The frozen dough according to claim 17, having a specific volume of less than 1.5 ml/g.

24. The frozen dough according to claim 17, wherein the specific volume of the dough increases to at least 2.0 ml/g when kept at a temperature of 20° C. for 6-24 hours.

25. The frozen dough according to claim 17, wherein the dough is a shaped dough having a weight in the range of 20-800 grams.

26. The frozen dough according to claim 17, wherein the dough comprises 40-80 wt. % of flour and 10-50 wt. % of water.

27. The frozen dough according to claim 17, wherein the dough is a bagel dough, a doughnut dough, a bread dough or a pastry dough.

28. A method of preparing a ready-to-eat cooked leavened dough product, said method comprising the steps of:
(a) thawing and leavening a frozen non-leavened farinaceous dough containing at least 10³ cells/g viable cells of an S. bayanus strain by keeping it under ambient temperature for 6-24 hours to obtain a leavened dough having a specific volume of at least 2.0 ml/g; and
(b) baking, frying and/or boiling the leavened dough.

29. The method according to claim 28, wherein the dough is kept under ambient conditions for 12-24 hours.

30. The method according to claim 29, wherein the dough is kept under ambient conditions overnight.

31. The method according to claim 28, wherein the method does not include proofing of the dough in a proofing cabinet.

32. The method according to claim 28, wherein the leavened dough is kept at refrigeration conditions for up to 16 hours before it is baked, fried and/or boiled.
